(19) United States
(12) Patent Application Publication
(10) Pub. No.: US 2025/0297581 A1
(43) Pub. Date: Sep. 25, 2025

(54) METHOD FOR OPERATING AN INTERNAL COMBUSTION ENGINE, CONTROL DEVICE FOR AN INTERNAL COMBUSTION ENGINE AND INTERNAL COMBUSTION ENGINE WITH A CONTROL DEVICE OF THIS TYPE

(71) Applicant: Rolls-Royce Solutions GmbH, Friedrichshafen (DE)

(72) Inventors: Peter Bretzel, Horgenzell (DE); Sebastian Wustl, Meersburg (DE); Benjamin Kleinherne, Friedrichshafen (DE)

(73) Assignee: Rolls-Royce Solutions GmbH, Friedrichshafen (DE)

(21) Appl. No.: 19/228,342

(22) Filed: Jun. 4, 2025

Related U.S. Application Data
(63) Continuation of application No. PCT/EP2023/084612, filed on Dec. 6, 2023.

(30) Foreign Application Priority Data
Dec. 16, 2022 (DE) 10 2022 133 770.7

(51) Int. Cl. F02D 41/00; F02D 9/02; F02D 35/00; F02P 5/145

(52) U.S. Cl. CPC F02D 41/0027; F02D 9/02; F02D 35/0046; F02P 5/145; F02D 2009/022

(57) ABSTRACT

A method for operating an internal combustion engine includes: introducing a fuel gas with a fluctuating hydrogen content into an air path of the internal combustion engine; adjusting a combustion air ratio for a combustion chamber of the internal combustion engine via a predeterminable fuel gas mass flow into the air path; adjusting a power variable of the internal combustion engine by a throttle valve that is arranged in the air path; detecting a nitrogen oxide concentration in an exhaust gas path of the internal combustion engine; adjusting the combustion air ratio depending on the nitrogen oxide concentration that is detected; detecting a throttle valve reserve in the air path; and selecting an ignition timing in the combustion chamber of the internal combustion engine depending on the throttle valve reserve that is detected.

### CROSS REFERENCE TO RELATED APPLICATIONS

This is a continuation of PCT application no. PCT/EP2023/084612, entitled “METHOD FOR OPERATING AN INTERNAL COMBUSTION ENGINE, CONTROL DEVICE FOR AN INTERNAL COMBUSTION ENGINE AND INTERNAL COMBUSTION ENGINE WITH A CONTROL DEVICE OF THIS TYPE”, filed Dec. 6, 2023, which is incorporated herein by reference. PCT application no. PCT/EP2023/084612 claims priority to German patent application no. 10 2022 133 770.7, filed Dec. 16, 2022, which is incorporated herein by reference.

### BACKGROUND OF THE INVENTION

### 1. Field of the Invention

The present invention relates to internal combustion engines.

### 2. Description of the Related Art

In particular, in consideration of climate protection, a progressive move toward a so-called hydrogen economy, in particular the use of hydrogen as fuel or fuel gas, is envisaged. In this context, it is planned specifically to mix hydrogen with other fuel gases, in particular in distribution networks for other fuel gases, in particular to feed into the natural gas grid. However, this virtually results in hydrogen concentrations that fluctuate with time, which causes problems in the operation of the internal combustion engine that use such fuel gas mixtures-also referred to below as fuel gas. Nitrogen oxide emissions, in particular, can fluctuate considerably and can also exceed a legally mandated limit value during operation of such an internal combustion engine. A simple way to consider the fluctuating hydrogen content in the fuel gas mixture is to use suitable sensors, especially a hydrogen sensor. However, this requires an additional component and additional control measures, which is complex and expensive. Deviation control of the fluctuating hydrogen content is also confronted with the problem that, in the course of adaptation, in particular to an increasing hydrogen content, a throttle valve reserve, which is indispensable for any load surges in regard to the dynamics of the combustion engine, can be quasi used up.

What is needed in the art is a method for operating an internal combustion engine, a control device for an internal combustion engine to carry out such a method, and an internal combustion engine with such a control device, whereby the aforementioned disadvantages are reduced, optionally do not occur.

### SUMMARY OF THE INVENTION

The invention relates to a method for operating an internal combustion engine, a control device for a combustion engine to carry out such a method, and an internal combustion engine with such a control device.

The present invention provides a method for operating an internal combustion engine, wherein a fuel gas with a fluctuating hydrogen content is introduced into an air path of the internal combustion engine; wherein a combustion air ratio for a combustion chamber of the internal combustion engine is adjusted via a predeterminable fuel gas mass flow that is to be introduced or has already been introduced into the air path; wherein a power variable of the internal combustion engine is adjusted by a throttle valve that is arranged in the air path; wherein a nitrogen oxide concentration in an exhaust gas path of the internal combustion engine is detected; wherein the combustion air ratio is adjusted depending on the detected nitrogen oxide concentration; wherein a throttle valve reserve is detected in the air path; and wherein an ignition timing in the combustion chamber of the internal combustion engine is selected depending on the detected throttle valve reserve. By adjusting the combustion air ratio depending on the detected nitrogen oxide concentration, the internal combustion engine can advantageously be adjusted to a fluctuating hydrogen content in the fuel gas without requiring a separate hydrogen sensor. It is thereby especially advantageously possible to adhere to a legally mandated nitrogen oxide limit. By additionally selecting the ignition timing in the combustion chamber, depending on the detected throttle valve reserve, depletion of the throttle valve reserve is advantageously avoided, and a necessary or desirable dynamic of the internal combustion engine for any load surges is maintained.

In the context of the present technical teaching, a fuel gas is understood to be, in particular a gaseous gas or gas mixture that is combustible at room temperature and ambient pressure, in particular at 25° C. and 1013 mbar. In particular, a fuel gas is understood to be a mixture of natural gas, in particular liquified natural gas (LNG) and hydrogen, in particular with variable hydrogen content.

In the context of the present technical teaching, a hydrogen content is understood to be in particular a hydrogen concentration or a hydrogen partial pressure.

In the context of the present technical teaching, a combustion air ratio is understood to be in particular a lambda value. The combustion air ratio is thus in particular the ratio of an actual air mass relative to a stoichiometric airmass that is required for complete combustion or, equivalently—the quotient from an actual ratio of air mass relative to fuel mass and a stoichiometric ratio of airmass relative to fuel mass.

In the context of the present technical teaching, a power variable is understood to be a physical variable, a measured value or parameter that is characteristic for the power of the internal combustion engine. In particular, the power variable can be the power itself. Alternatively, or in addition, the power variable can also be a torque of the internal combustion engine, or another suitable variable.

The fact that the combustion air ratio is adjusted depending on the detected nitrogen oxide concentration means, in particular, that the specifiable fuel gas mass flow is adjusted depending on the detected nitrogen oxide concentration.

In the context of the present technical teaching, a throttle valve reserve is understood in particular to be a pressure difference in the air path across the throttle valve, in particular a pressure drop across the throttle valve, in particular a difference between a first pressure in the air path-especially directly-upstream of the throttle valve and a second pressure in the air path—in particular indirectly-downstream of the throttle valve.

The internal combustion engine is operated, in particular, in a characteristic map with a combustion air ratio of 1 at no load and 1.75 to 2, in particular up to 1.8, at rated load operation, whereby the internal combustion engine is operated in a load range, that is, in particular above an idle speed in the lean range, in particular with a combustion air ratio of up to 2, in particular to 1.8. This means, in particular, that the internal combustion engine is optionally operated at least at full load in such a way that the air combustion ratio does not drop below 1.8 or not below 1.75. Thus, the internal combustion engine is in particular a lean burn gas engine.

According to a further development of the present invention it is provided that the power variable is regulated by way of a throttle valve to a setpoint. The internal combustion engine can thus be operated advantageously in a controlled manner by the power variable. The setpoint can be, in particular, constant, or temporally variable.

According to a further development of the present invention it is provided that the combustion air ratio is increased, meaning in particular that the predeterminable fuel gas mass flow is reduced if the detected nitrogen oxide concentration is greater than a target nitrogen oxide concentration, wherein the combustion air ratio is reduced, that is in particular the predeterminable fuel gas mass flow is increased, if the detected nitrogen oxide concentration is less than the target nitrogen oxide concentration. Alternatively, or in addition, no change in the combustion air ratio occurs if the detected nitrogen oxide concentration is equal to the target nitrogen oxide concentration.

An increase in the hydrogen content in the fuel gas leads in particular to a faster combustion process in the combustion chamber, in other words to a faster and hotter combustion, so that the nitrogen oxide concentration in the exhaust gas increases. If now the combustion air ratio is suitably increased, the combustion process slows down and the nitrogen oxide concentration decreases. Simultaneously however, the power of the internal combustion engine decreases; in order to compensate for this, the throttle valve is opened further by the power control. This results in a decrease of the throttle valve reserve. If, in contrast, the hydrogen content in the fuel gas decreases, the combustion process slows down; the nitrogen oxide concentration decreases, and the combustion air ratio can be reduced; this means that the fuel gas mass flow into the air path is increased. At the same time, the power of the internal combustion engine increases; to compensate for this, the power control closes the throttle valve slightly, so that the throttle valve reserve increases. Thus, the internal combustion engine is regulated to the fluctuating hydrogen content; at the same time, the hydrogen content in the fuel gas and deviation control thereof influences the throttle valve reserve.

The target nitrogen oxide concentration corresponds in particular to the legally mandated nitrogen oxide limit value. With a view toward achieving the highest possible level of efficiency of the internal combustion engine, the herein outlined measures are adopted in particular so that the current nitrogen oxide concentration corresponds as precisely as possible to the legally mandated nitrogen oxide limit value. In particular, the nitrogen oxide concentration in the exhaust gas is increased if the current nitrogen oxide concentration is less than the nitrogen oxide limit value. In one embodiment, the nitrogen oxide concentration is consistent in particular with the legally mandated nitrogen oxide limit value, less a safety margin, wherein the safety margin takes into account, in particular, possible ageing effects, sensor scattering or other emission reducing effects. With a view to achieving the highest possible efficiency of the internal combustion engine, the herein explained measures are implemented in particular so that the current nitrogen oxide concentration corresponds as precisely as possible to the legally mandated nitrogen oxide limit value less the safety margin. The nitrogen oxide concentration in the exhaust gas is increased in particular if the current nitrogen oxide concentration is less than the nitrogen oxide limit value less the safety margin.

In one embodiment, the combustion air ratio-in particular, originating from a current value-is incrementally increased if the detected nitrogen oxide concentration is greater than the target nitrogen oxide concentration. Alternatively, or in addition, the combustion air ratio-in particular, originating from a current value-is incrementally reduced, if the detected nitrogen oxide concentration is less than the target nitrogen oxide concentration.

In one embodiment, the combustion air ratio is varied in a load range of 1.8 to 2, in particular to 2.0.

Alternatively, or in addition, one increment for the change in the combustion air ratio (lambda-increment) is 0.01 to 0.03, in particular 0.02.

A further development of the invention provides that the ignition timing is retarded if the detected throttle valve reserve reaches or drops below a predetermined minimum reserve value-s in particular from above, that is from higher values, wherein the ignition timing is advanced after a retard setting, if the detected throttle valve reserve exceeds a predetermined minimum reserve value, in particular plus a predetermined hysteresis value. In particular, the ignition timing is advanced only if it was previously adjusted to retard and in particular if a previous retard setting has not already been compensated for by subsequent advance adjustments. If the ignition timing is retarded, this results in combustion in the combustion chamber taking place at a lower temperature, which reduces the nitrogen oxide concentration in the exhaust gas; at the same time, however, the exhaust gas temperature increases due to lower expansion cooling in the expansion stroke; as a result, more enthalpy is supplied to a turbine of an exhaust gas turbocharger arranged in the exhaust gas path of the internal combustion engine, whereby a compressor of the exhaust gas turbocharger which is arranged in the air path upstream of the throttle valve and which is drive-and operatively connected to the turbine receives more power. This in turn increases the pressure in the air path; at the same time, the power of the internal combustion engine increases, which in turn is compensated for by the power control by closing the throttle valve slightly. This again increases the throttle valve reserve. If, conversely, the ignition timing is advanced, the result is that combustion in the combustion chamber occurs at a higher temperature, which increases the nitrogen oxide concentration in the exhaust gas; at the same time, the exhaust gas temperature drops due to the higher expansion cooling; thus, less enthalpy is supplied to the turbine, so that the compressor receives less power. This again reduces the pressure in the air path; the power output of the internal combustion engine decreases simultaneously, which in turn is compensated for by the power control in that the throttle valve is opened further. This lowers the throttle valve reserve.

The inventors have recognized in particular that the ignition timing adjustment has an advantageous effect with regard to the nitrogen oxide concentration on the one hand and the throttle valve reserve on the other, precisely opposite to the change in the combustion air ratio, so that the ignition timing adjustment can be used advantageously to lower the nitrogen oxide concentration and at the same time restore the throttle valve reserve, if this is almost depleted by a change in the combustion air ratio to reduce the nitrogen oxide concentration, in particular if therefore a further change in the combustion air ratio towards a decreasing nitrogen oxide concentration is no longer possible or is associated with serious disadvantages with regard to the dynamics of the internal combustion engine.

In the context of the present technical teaching, an adjustment to retard the ignition timing is understood in particular to mean that a crankshaft angle value, at which the ignition occurs within an operating cycle, is shifted closer to an upper dead center of a piston or is changed to a higher value. Accordingly, an adjustment advancing the ignition timing is understood to mean in particular that the crankshaft angle value at which ignition takes place within the operating cycle is shifted further away from top dead center or is changed to a lesser value. In the case of an internal combustion engine designed as a four-stroke engine, an operating cycle extends in particular from 0° KW (crankshaft angle) to 720° KW, but in the case of a two-stroke engine from 0° KW to 360° KW.

In one embodiment, the ignition timing—in particular, starting from a current value—is incrementally retarded, if the detected throttle valve reserve reaches or drops below a predetermined minimum reserve value. Alternatively, or in addition, the ignition timing—in particular, starting from a current value—is incrementally advanced, when the detected throttle valve reserve exceeds a predetermined minimum reserve value, in particular in addition to the predetermined hysteresis value. In one embodiment, the predetermined minimum reserve value is 100 mbar to 300

mbar, optionally to 250 mbar, optionally to 200 mbar, optionally to 150 mbar. Alternatively, or in addition, the predetermined hysteresis value is 30 mbar to 70 mbar, in particular 40 mbar to 60 mbar, in particular 50 mbar.

In one embodiment the adjustment range for retarding the ignition timing is 0.1° KW to 15° KW, in particular to 12° KW, in particular to 10° KW, in particular to 8° KW. In one embodiment an increment for adjustment of the ignition timing is 0.5° KW (ignition timing increment).

According to a further development of the present invention, it is provided that the ignition timing is advanced only as long as previous retardation adjustments have not yet been compensated. This advantageously prevents the ignition timing, in particular starting from a value intended for normal operation, from being selected too early, which could lead in particular to knocking combustion or to damage or even destruction of the internal combustion engine.

According to a further development of the present invention, it is provided that an alarm is issued, if the detected throttle valve reserve reaches or drops below the predetermined minimum reserve value—in particular from above, that is from higher values—and at the same time the ignition timing reaches or exceeds a predetermined maximum ignition timing, and at the same time the detected nitrogen oxide concentration is greater than the predetermined target nitrogen oxide concentration. In this case in particular, all measures for lowering the nitrogen oxide concentration are exhausted. A further increase in the combustion air ratio is out of the question since this would cause total depletion of the throttle valve reserve. Also, an additional retardation of the ignition timing is out of the question, since in particular, the predetermined maximum ignition timing is selected in such a way, that an even later ignition timing would no longer ensure operation of the internal combustion engine with acceptable power or efficiency, or complete combustion, or any combustion at all in the combustion chamber. This in turn means that the legally mandated nitrogen oxide limit value can no longer be adhered to. The alarm advantageously allows the operator of the internal combustion engine to be alerted to this situation. The operator can then take appropriate measures, for example by intervening in the fuel gas supply or the fuel gas composition or shutting down the internal combustion engine. This can also occur automatically, without the need of manual intervention.

According to a further development of the present invention, it is provided that the throttle valve reserve is adjusted via a bypass path setting device arranged in a compressor bypass path bypassing the compressor arranged in the air path, whereby a flow cross-section of the compressor bypass path is changed by controlling the bypass path setting device. Changing the flow cross-section of the compressor bypass path advantageously allows the throttle valve reserve to be adjusted, in particular regulated, during operation of the internal combustion engine when the throttle valve position is changed. In particular, the throttle valve reserve increases when the bypass path setting device is controlled towards a reduction in the flow cross-section of the compressor bypass path, in particular when it is closed; vice versa, the throttle valve reserve decreases when the bypass path setting device is controlled towards an increase in the flow cross-section of the compressor bypass path, in particular when it is opened. With the help of the bypass path setting device, aging or contamination of the compressor can be compensated for, in particular by more frequently closing the bypass path setting device during the service life of the compressor.

In one embodiment, the bypass setting device is designed as a valve or as a bypass flap.

According to a further development of the present invention, it is provided that the ignition timing is retarded only, if a predetermined closing position of the bypass path setting device—in particular starting from an open position—has been reached or exceeded, in particular in direction of a closed position, that is a completely closed position. Advantageously, the throttle valve reserve is therefore initially regulated by way of the bypass path control device, and the ignition timing is only adjusted once this option has been exhausted. In particular, more moderate remedies of maintaining the throttle valve reserve are thus first used before a measure is taken that intervenes more aggressively in the functioning of the internal combustion engine.

The present invention also provides a control device for an internal combustion engine that is arranged to carry out an inventive method or a method according to one or a number of the previously described embodiments. In connection with the control device, advantages arise which were already previously discussed in connection with the method.

The present invention also provides an internal combustion engine which has a gas injection device, in particular a gas injection valve, wherein the gas injection device is arranged and designed to introduce a fuel gas into an air path of the internal combustion engine. The internal combustion engine also has a throttle valve which is arranged in the air path, and a nitrogen oxide sensor arranged in an exhaust gas path of the internal combustion engine. In addition, the internal combustion engine has an ignition device arranged in a combustion chamber of the internal combustion engine, and a control device according to the present invention or a control device according to one or a number of the previously described embodiments. The control device is operatively connected with the gas injection device, the throttle valve, and the nitrogen oxide sensor. In connection with the internal combustion engine, the advantages arise in particular that have already been explained in connection with the process or the control device.

According to a further development of the present invention it is provided that the internal combustion engine has a compressor in the air path, wherein the internal combustion engine moreover has a compressor bypass path around the compressor, wherein a bypass path setting device is arranged in the compressor bypass path which is designed to change a flow cross section of the compressor bypass path, and wherein the control device is operatively connected with the bypass path setting device.

In one embodiment, the internal combustion engine has a turbine in an exhaust gas path, which is drive- and operatively connected with the compressor. The internal combustion engine has, in particular, an exhaust gas turbocharger which, on the one hand has a compressor located in the air path and on the other hand a turbine which is arranged in the exhaust gas path, and which is drive- and operatively connected with the compressor.

In one embodiment, the internal combustion engine—in particular upstream of the nitrogen oxide sensor—has a catalytic converter to reduce nitrogen oxide, in particular for selective catalytic reduction (SCR-catalytic converter).

### BRIEF DESCRIPTION OF THE DRAWINGS

The above-mentioned and other features and advantages of this invention, and the

manner of attaining them, will become more apparent and the invention will be better understood by reference to the following description of embodiments of the invention taken in conjunction with the accompanying drawings, wherein:

FIG. 1 is a schematic representation of one design example of an internal combustion engine with a design example of a control device;

FIG. 2 is a first schematic representation of a design example of the method in the form of a flow chart; and

FIG. 3 a second schematic representation of the method.

Corresponding reference characters indicate corresponding parts throughout the several views. The exemplifications set out herein illustrate embodiments of the invention, and such exemplifications are not to be construed as limiting the scope of the invention in any manner.

### DETAILED DESCRIPTION OF THE INVENTION

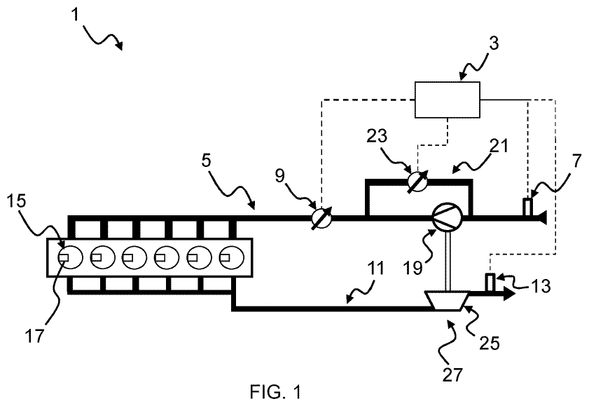

FIG. 1 is a schematic representation of a design example of an internal combustion engine 1 with a design example of a control device 3.

Internal combustion engine 1 has an air path 5 and a gas injection device 7, in particular a gas injection valve in air path 5, wherein gas injection device 7 is arranged and designed to introduce a fuel gas having a temporally fluctuating hydrogen component into air path 5. Internal combustion engine 1 moreover has a throttle valve 9 arranged in air path 5, and a nitrogen oxide sensor 13, arranged in an exhaust gas path 11 of internal combustion engine 1. Furthermore, internal combustion engine 1 has an ignition device 17 arranged in combustion chamber 15 of internal combustion engine 1. For the sake of clarity, only one combustion chamber 15 and only one ignition device 17 are identified with the corresponding reference symbol. Control device 3 is operatively connected with gas injection device 7, throttle valve 9 and nitrogen oxide sensor 13. It is designed, in particular, to carry out a process described in more detail below.

In particular, internal combustion engine 1 has a compressor 19 in air path 5, as well as a compressor bypass path 21 around compressor 19, wherein a bypass path setting device 23, in particular a bypass flap, is arranged in compressor bypass path 21. The latter is designed to change the flow cross section of compressor bypass path 21. Control device 3 is operatively connected with bypass path setting device 23.

In particular, internal combustion engine 1 also has a turbine 25 in exhaust gas path 11, which is drive-and operatively connected with compressor 19. Internal combustion engine 1 has, in particular, an exhaust gas turbocharger 27, which has on the one hand compressor 19 arranged in air path 5 and on the other hand turbine 25 which is arranged in exhaust gas path 11 and is drive-and operatively connected with compressor 19.

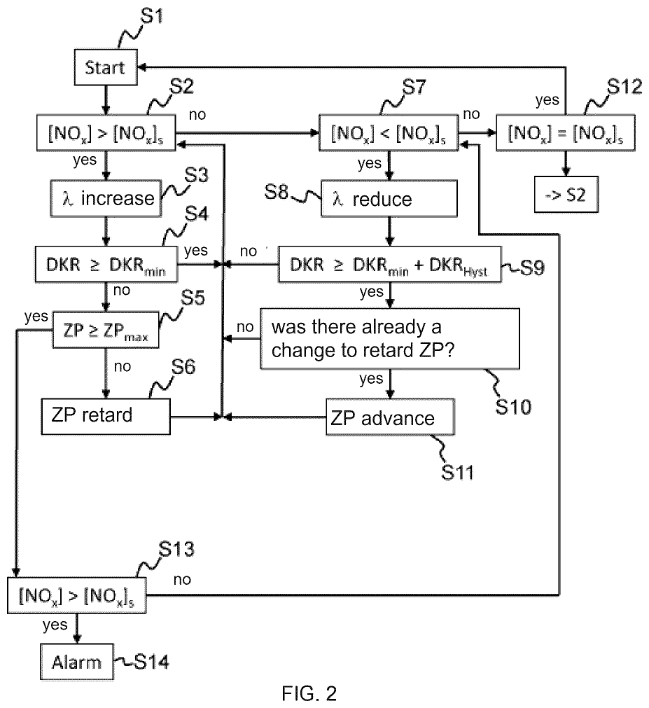

FIG. 2 is a first schematic representation of a design example of the process in the form of a flow chart.

Identical and functionally identical elements are provided with the same reference symbols in all drawings, so that reference is made respectively to the previous description.

In the herein illustrated design example, the process starts in a first step S1. In a second step S2, it is verified whether a nitrogen oxide concentration [NOₓ] in the exhaust gas detected by nitrogen oxide sensor 13—in particular, an actual nitrogen oxide concentration-is greater than a predetermined target nitrogen oxide concentration [NOₓ]ₛ, wherein the predetermined target nitrogen oxide concentration [NOₓ]ₛ corresponds in particular to a legally mandated limit value—optionally minus a safety margin. If this is the case, combustion air ratio λ is increased in a third step S3 starting from a current value—in particular by a predetermined lambda increment—in particular by suitably controlling gas injection device 7 in order to reduce—in particular incrementally—a mass flow of combustion gas into air path 5. Subsequently it is verified in a fourth step S4 whether a throttle valve reserve DKR—in particular, an actual throttle valve reserve-has reached or exceeded a predetermined minimum reserve value DKRₘᵢₙ. If this is the case, the process is continued in second step S2.

If, on the other hand throttle valve reserve DKR drops below predetermined minimum reserve value DKRₘᵢₙ, it is verified in a fifth step S5, whether an ignition timing ZP, in particular a current actual ignition timing reaches or exceeds a predetermined maximum ignition timing ZPₘₐₓ. If this is not the case, ignition timing ZP is retarded in a sixth step S6—especially by a predetermined ignition timing increment—starting from its current value. Optionally, however, ignition timing ZP is only retarded in sixth step S6 if bypass path setting device 23 has reached or exceeded a predetermined closing position. The process is then continued in second step S2.

If it is determined in second step S2 that nitrogen oxide concentration [NOₓ] is not greater than target nitrogen oxide concentration [NOₓ]ₛ, it is verified in a seventh step S7 whether nitrogen oxide concentration [NOₓ] is less than the target nitrogen oxide concentration [NOₓ]ₛ. If this is the case, combustion air ratio A is reduced in an eighth step S8 starting from its current value—in particular by the predetermined lambda increment—in particular by suitably controlling gas injection device 7 in order to increase the mass flow of combustion gas into air path 5—in particular incrementally. It is then verified in a ninth step S9, whether throttle valve reserve DKR reaches or exceeds the predetermined minimum reserve value DKRₘᵢₙ plus a predetermined hysteresis value DKR_{Hyst}. If this is not the case, the process is continued in second step S2.

If, however, throttle reserve DKR exceeds the predetermined minimum reserve value DKRₘᵢₙ plus the predetermined hysteresis value DKR_{Hyst}, it is verified in a tenth step S10 whether ignition timing ZP has already been changed to retard. If this is the case, and in particular if the retard adjustment has not already been compensated for by subsequent advance adjustments, ignition timing ZP is readjusted to an advance setting in an eleventh step S11, starting from its current value—in particular by the predetermined ignition timing increment. The process is then continued in step S2.

If, in contrast it is determined in tenth step S10, that previously no change to retard the ignition timing ZP has yet occurred, the process is continued in second step S2, directly following tenth step S10.

If it is determined in seventh step S7, that the nitrogen oxide concentration [Noₓ] is not less than the target nitrogen oxide concentration [Noₓ]ₛ, it is verified in a twelfth step S12 whether the nitrogen oxide concentration [Noₓ] is equal to the target nitrogen oxide concentration [Noₓ]ₛ. If this is the case, no further action will be taken and—after a predetermined optional waiting period-the process is restarted in first step S1. If this is not the case—which based on the intrinsic logic of the process should actually not be the case but could possibly occur as an exception in the event of high-frequency fluctuations in the hydrogen content—the process is continued in step S2.

If it is determined in fifth step S5 that ignition timing ZP reaches or exceeds the predetermined maximum ignition timing ZPₘₐₓ, it is verified again in a thirteenth step S13, whether the nitrogen oxide concentration [Noₓ] is greater than the predetermined target nitrogen oxide concentration [Noₓ]ₛ. If this is not the case, the process is continued in seventh step S7.

If, on the other hand, the nitrogen oxide concentration [NOₓ] in thirteenth step S13 exceeds the predetermined target nitrogen oxide concentration [NOₓ]ₛ, an alarm is issued in a fourteenth step S14. The process optionally ends herewith. Alternatively, the process can also be restarted in first step S1, especially following measures that have been implemented in response to the alarm.

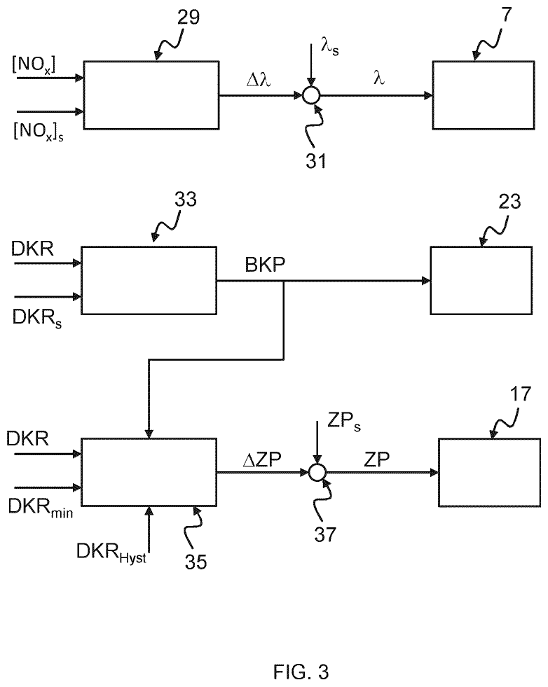

FIG. 2 shows the process in a sequence of discrete steps that are implemented successively. While it is possible in one design example, to carry out the method in this way this illustration serves in particular to provide a better understanding of the structure of the method. In fact, the method is optionally carried out simultaneously by a plurality of control devices, in particular in another embodiment example, as explained below in connection with FIG. 3.

In this respect, FIG. 3 illustrates a second schematic representation of the method. In the design example shown here, the actual nitrogen oxide concentration [NOₓ] and the target nitrogen oxide concentration [NOₓ]ₛ are fed into a nitrogen oxide control device 29. Nitrogen oxide control device 29 calculates an offset combustion air ratio Δλ from a control deviation calculated from this, which is offset in a first calculation element 31 with a target combustion air ratio λₛ read in particular from a characteristic map to form a combustion air ratio λ. Combustion air ratio λ is used to control gas injection device 7 in order to adjust combustion air ratio λ.

At the same time, the actual throttle valve reserve DKR and a target throttle valve reserve DKRs are entered into a bypass flap control device 33, which is provided for adjusting the position of bypass path setting device 23. Bypass flap control device 33 calculates a bypass flap position BKP from a control deviation calculated from this, which is used to control bypass path setting device 23.

Bypass flap position BKP is also transmitted to an ignition time control device 35, wherein bypass flap position BKP is used in particular, to activate or trigger ignition timing control device 35. In particular, ignition timing control device 35 is inactive, as long as bypass flap position BKP has not reached or exceeded a predetermined closing position. If bypass flap position BKP reaches or exceeds the predetermined closing position, ignition timing control device 35 is activated. Optionally, ignition timing control device 35 is again deactivated, when bypass flap position BKP drops again below the predetermined closing position.

If ignition timing control device 35 is active, it calculates an offset ignition timing AZP from the actual throttle valve reserve DKR and the reserve minimum value DKRₘᵢₙ, which is offset in a second calculation element 37 with a target ignition timing ZPs read in particular from a characteristic map to form an ignition timing ZP, which is then used to control ignition device 17. In particular, predetermined hysteresis value DKR_{Hyst} is still included in ignition timing control device 35 in order to reset ignition timing ZP to advance only if throttle valve reserve DKR exceeds the reserve minimum value DKRₘᵢₙ plus the predetermined hysteresis value DKR_{Hyst}.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method for operating an internal combustion engine, the method comprising the steps of:
introducing a fuel gas with a fluctuating hydrogen content into an air path of the internal combustion engine;
adjusting a combustion air ratio for a combustion chamber of the internal combustion engine via a predeterminable fuel gas mass flow into the air path;
adjusting a power variable of the internal combustion engine by a throttle valve that is arranged in the air path;
detecting a nitrogen oxide concentration in an exhaust gas path of the internal combustion engine;
adjusting the combustion air ratio depending on the nitrogen oxide concentration that is detected;
detecting a throttle valve reserve in the air path; and
selecting an ignition timing in the combustion chamber of the internal combustion engine depending on the throttle valve reserve that is detected.

2. The method according to claim 1, wherein the power variable is regulated by way of the throttle valve to a setpoint.

3. The method according to claim 1, wherein the combustion air ratio is increased if the nitrogen oxide concentration that is detected is greater than a target nitrogen oxide concentration, and wherein the combustion air ratio is reduced if the nitrogen oxide concentration that is detected is less than the target nitrogen oxide concentration.

4. The method according to claim 1, wherein the ignition timing is retarded if the throttle valve reserve that is detected reaches or drops below a predetermined minimum reserve value, and wherein the ignition timing is advanced after a retard setting if the throttle valve reserve that is detected exceeds the predetermined minimum reserve value.

5. The method according to claim 4, wherein the ignition timing is advanced after the retard setting if the throttle valve reserve that is detected exceeds the predetermined minimum reserve value plus a predetermined hysteresis value.

6. The method according to claim 4, wherein the ignition timing is advanced as long as previous retard adjustments have not yet been compensated.

7. The method according to claim 1, wherein an alarm is issued if the throttle valve reserve that is detected reaches or drops below a predetermined minimum reserve value and at the same time the ignition timing reaches or exceeds a predetermined maximum ignition timing and at the same time the nitrogen oxide concentration that is detected is greater than a predetermined target nitrogen oxide concentration.

8. The method according to claim 1, wherein the throttle valve reserve is adjusted via a bypass path setting device arranged in a compressor bypass path bypassing a compressor arranged in the air path, wherein a flow cross-section of the compressor bypass path is changed by controlling the bypass path setting device.

9. The method according to claim 8, wherein the ignition timing is retarded only if a predetermined closing position in the bypass path setting device has been reached or exceeded.

10. A control device for an internal combustion engine, the control device comprising:
the control device, which is configured for carrying out a method for operating the internal combustion engine, the method including the steps of:
introducing a fuel gas with a fluctuating hydrogen content into an air path of the internal combustion engine;
adjusting a combustion air ratio for a combustion chamber of the internal combustion engine via a predeterminable fuel gas mass flow into the air path;
adjusting a power variable of the internal combustion engine by a throttle valve that is arranged in the air path;
detecting a nitrogen oxide concentration in an exhaust gas path of the internal combustion engine;
adjusting the combustion air ratio depending on the nitrogen oxide concentration that is detected;
detecting a throttle valve reserve in the air path; and
selecting an ignition timing in the combustion chamber of the internal combustion engine depending on the throttle valve reserve that is detected.

11. An internal combustion engine, comprising:
an air path;
a gas injection device configured for introducing a fuel gas into the air path of internal combustion engine;
a throttle valve which is arranged in the air path;
an exhaust path;
a nitrogen oxide sensor arranged in the exhaust gas path;
a combustion chamber;
an ignition device arranged in the combustion chamber;
a control device, which is operatively connected with the gas injection device, the throttle valve, and the nitrogen oxide sensor, the control device being configured for carrying out a method for operating the internal combustion engine, the method including the steps of:
introducing the fuel gas with a fluctuating hydrogen content into the air path of the internal combustion engine;
adjusting a combustion air ratio for the combustion chamber of the internal combustion engine via a predeterminable fuel gas mass flow into the air path;
adjusting a power variable of the internal combustion engine by the throttle valve that is arranged in the air path;
detecting a nitrogen oxide concentration in the exhaust gas path of the internal combustion engine;
adjusting the combustion air ratio depending on the nitrogen oxide concentration that is detected;
detecting a throttle valve reserve in the air path; and
selecting an ignition timing in the combustion chamber of the internal combustion engine depending on the throttle valve reserve that is detected.

12. The internal combustion engine according to claim 11, wherein the internal combustion engine further includes a compressor, a compressor bypass path, and a bypass path setting device, the compressor being in the air path, the compressor bypass path being around the compressor, the bypass path setting device being arranged in the compressor bypass path and being configured for changing a flow cross-section of the compressor bypass path, the control device being operatively connected with the bypass path setting device.
